(19) United States
(12) Patent Application Publication
(10) Pub. No.: US 2012/0210949 A1
(43) Pub. Date: Aug. 23, 2012

(54) Dog grooming salon chair

(76) Inventor: Shannon D. Polacek, New Kensington, PA (US)

(21) Appl. No.: 12/932,401

(22) Filed: Feb. 23, 2011

(51) Int. Cl. A01K 13/00; A01K 15/04

(52) U.S. Cl. 119/756

(57) ABSTRACT

A dog grooming salon chair having a supported seat with a chair back and wherein the seat is dimension to receive and confine the hind rump portion of a dog in a seated position with the rear paws of the dog exposed forward for grooming. A forward protruding front paw tray is removably secured on the chair and positioned above the seat and dimensioned and adjustable to confine the chest area of the seated dog in relation to the chair back whereby the front paws of the seated dog are supported on the front paw tray for grooming. A tether is secured to the chair and detachably secured to the dog, as by a harness, and dimensioned to thereby retain the dog in the chair in a seated position for grooming.

### BACKGROUND OF THE INVENTION

The present invention pertains to pet grooming, and more particularly to a dog grooming salon chair.

Dogs are generally groomed on a grooming table with the dog standing on the table and restrained by the neck, a harness or other arrangement to keep the dog in a standing position during grooming.

The dog is generally constrained by a loop around the neck which can become uncomfortable for the dog or cause the dog to struggle during grooming. Injuries can occur to the dog by falling or jumping off the side of the table. In addition, the groomer does not have good access to the pet's nails and the dog's foot or feet will generally excessively move about thereby causing undesirable results when toenail trimming.

Also, it is sometimes necessary to remove the loop from the pet's neck in order to shave or comb the dog's neck, at which time control can be difficult and the dog can be injured.

It is accordingly an object of the present invention to provide a dog grooming support which eliminates the aforementioned problems and difficulties and provides a more pleasant experience for the dog being groomed, the groomer and the owner of the dog.

### SUMMARY OF THE INVENTION

The present invention provides a dog grooming salon chair having a supported seat with a chair back wherein the seat is dimensioned to receive and confine the hind rump portion of a dog in a seated position with the rear paws of the dog exposed forward for grooming. A forward protruding front paw tray is removably secured on the chair and positioned above the seat and dimensioned and adjustable to confine the chest area of the seated dog in relation to the chair back, whereby the front paws of the seated dog may be supported on the front paw tray for grooming. A tether, consisting of one or more tether lines is secured to the chair and detachably securable to the dog and dimensioned to thereby restrain the dog in the chair in the seated position for grooming. The tether is preferably secured to a harness on the dog. For example, the tether may be comprised of two straps with outer ends thereof secured respectively to spaced side portions of the chair with inner ends thereof secured to a harness on the dog. Alternatively or additionally a tether may depend from the back of the dog harness to a tether hook on the back of the chair.

The dog grooming salon chair of the present invention may further include a rear paw tray protruding forward from the chair and positioned to receive and support the rear paws of the dog overhanging a front portion of the seat for grooming the rear paws while the dog is seated in the chair. This rear paw tray is preferably adjustably slidable into and out of the chair.

The top surfaces of the front paw tray and the rear paw tray are preferably provided with a non-skid surface.

The chair back also preferably includes an opening adjacent to the seat for protrusion therethrough of the dog's tail. The chair back may also be displaceable for permitting access for larger dogs to walk into the chair from the back.

The dog grooming salon chair of the present invention is also preferably provided with a seat height adjuster, such as a hydraulic foot pump mechanism of conventional type for raising and lowering the chair, as typically found on salon chairs.

With the dog grooming salon chair of the present invention, the pet is more comfortably , restrained making tasks, such as trimming toenails, plucking ear hair, trimming hair on the face, painting toenails and any other toenail grooming, cleaning ears, and possibly shaving neck hair, shaving or trimming pad hair and brushing and trimming nail hair, all of which makes it much physically easier on the groomer and the pet.

Also, less injuries will occur to the pet since the dog will be held in place more comfortably by a harness rather than a loop around their neck when they become uncomfortable or struggle during grooming. With the chair of the present invention the set cannot fall or jump off the side of the apparatus, as in the situation of a grooming table, and accordingly hurt their necks by hanging from the loop. Additionally, as can be encountered with grooming tables, the dog will not fall or jump off the table if they get their head out of the restraining loop. In fact, in extreme cases involving the use of a grooming loop with a grooming table, some pets have been known to rupture an eyeball during their grooming. The comfortable harness and seating arrangement of the present invention eliminates all of these worries for the groomer and the pet owners.

The dog grooming salon chair of the present invention provides better and easier access to the pet's nails without having to pull the standing pet's foot from the table surface or having the pet's foot move around on the table surface, thereby permitting the groomer to concentrate on the toenail without the foot moving all around, which will lead to better results in the toenail trimming.

The pet is restrained in the seated position thereby greatly reducing the possibility of the pet squirming around, which may cause injuries, for example, when brushing the ears, when cleaning or plucking ear hair, cutting with scissors or clippers on the ears, around the eyes, or other parts of the face, clipping of pads with scissors or clippers while pulling of the tail during brushing or trimming of the tail hair.

The confinement of the chair and the comfortable harness also eliminate the need to shave or comb the pet's neck on a grooming table, which is very risky. On a grooming table, it is often necessary to remove the loop from the pet's neck in order to shave or comb their neck. This can result in the pet making a sudden movement which can cause them to fall or jump from the table.

The dog grooming salon chair of the present invention also provides satisfaction to the pet owner as the pet owner sees that the salon chair of the present invention is more comfortable and safer.

The dog grooming salon chair of the present invention will also help lower the number of dog bite injuries that groomers sometimes have to endure. This is due to the fact that the dog is better restrained and calmer in the grooming chair of the present invention verses a grooming table. In addition, the pet feels safer and more comfortable sitting in the chair.

### BRIEF DESCRIPTION OF THE DRAWINGS

Other objects and advantages appear hereinafter in the following description and claims. The accompanying drawings show, for the purpose of exemplification, without limiting the scope of the invention or appended claims, certain practical embodiments of the present invention wherein:

FIG. 1 is a perspective front view of the dog grooming salon chair of the present invention with a dog restrained therein in a seated position for grooming;

FIG. 2 is a front perspective view of the dog grooming salon chair shown in FIG. 1 without the dog and with the front paw tray hinged to the open position;

FIG. 3 is a perspective left side view of the dog grooming salon chair of FIG. 1 shown with the dog removed from the chair; and

FIG. 4 is a rear view of the dog grooming salon chair shown in FIG. 1 with the dog removed and the front paw tray swung to the open position.

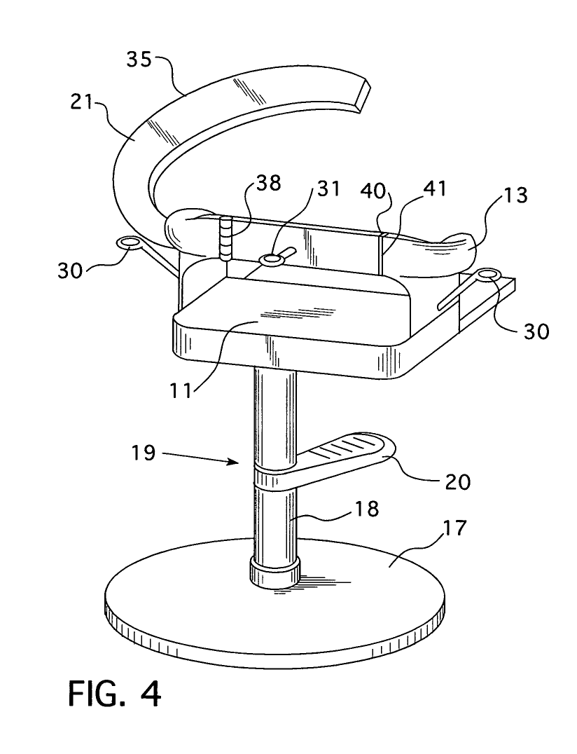

### DETAILED DESCRIPTION OF A PREFERRED EMBODIMENT

The dog grooming salon chair 10 of the present invention is comprised of a seat 11 having chair sides 12 and a chair back 13. The seat 11 is dimensioned to receive and confine the hind rump portion 14 of dog 15 in a seated position with the rear paws 16 of the dog 15 exposed forward for grooming. Salon chair 10 is supported from a ground surface with a chair base 17, which includes a support post 18 which includes a seat height adjuster 19 in the form of a conventional hydraulic foot operated lift 20 commonly found on present day salon chairs.

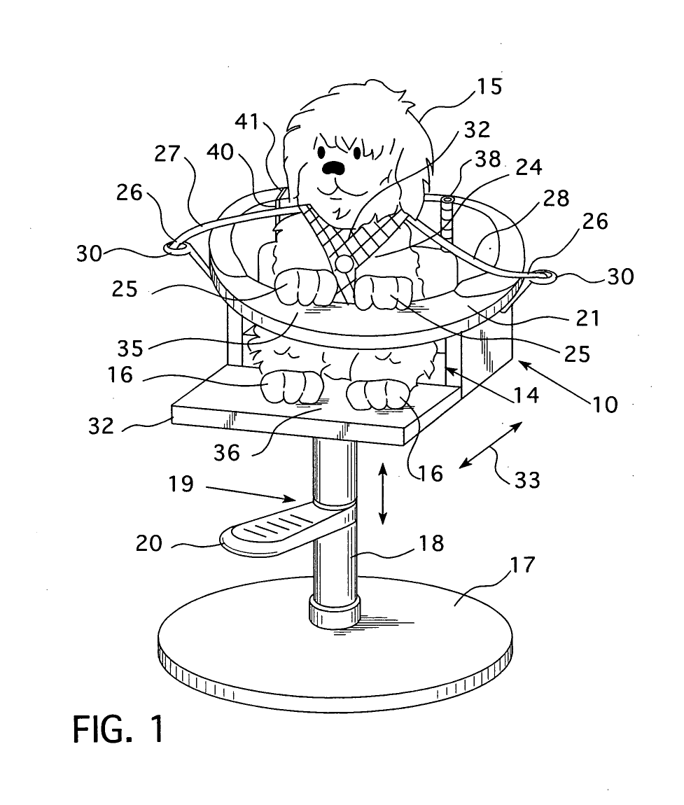

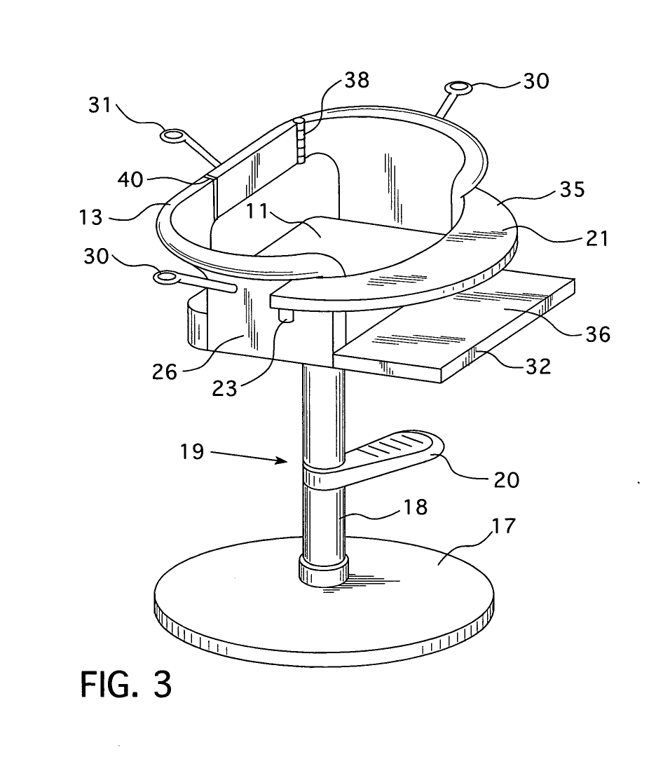

A forward protruding front paw tray 21 is removably secured on chair 10 by swinging to an open position on hinge 22. When closed as shown in FIGS. 1 and 3, the tray 21 is adjustably secured to catch 23. Front paw tray 21 is positioned above the seat 11 and dimensioned and adjustable in and out to confine the chest area 24 of the seated dog 15 in relation to the chair back 13 whereby the front paws 25 of seated dog 15 are supported on front paw tray 21 for grooming.

A tether 26, is here provided in the form of two straps 27 and 28 secured respectively to the spaced side portions of chair 10 by means of tether retainers 30. A rear tether retainer 31 is provided on back 13 for securement of an additional tether strap 26. The inner ends of the straps 26 are secured to the dog harness 32 in order to retain the dog 15 in the seated position shown in chair 10. Front paw tray 21 is positioned above seat 11 and dimensioned and adjustable to confine the chest area 24 in relation to the chair back 13 whereby the front paws 25 of the seated dog are supported on the front paw tray 21 for grooming. A rear paw tray 32 protrudes forward from chair 10 and is positioned to receive and support the rear paws 16 of dog 15 as they overhang the front portion of seat 11 for grooming the rear paws. Rear paw tray 32 is slidable into and out of chair 10 for adjustability purposes as indicated by arrow 33.

The top surface 35 of front paw tray 21 and the top surface 36 of rear paw tray 32 are provided with a non-skid surface.

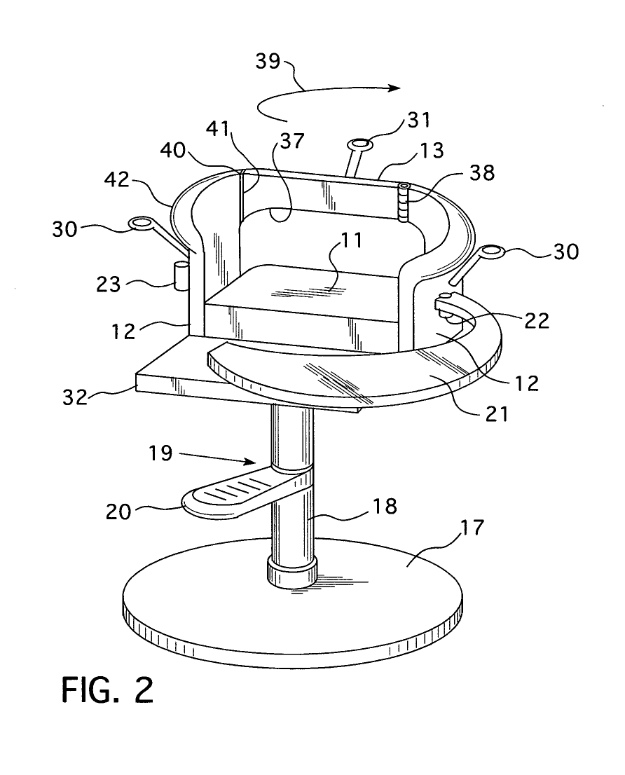

Chair back 13 is also provided with an opening 37 for protrusion therethrough of the tail of dog 15. Chair back 13 is also displaceable for permitting access for larger dogs to walk into chair 10 from the back. As is illustrated in FIG. 2, chair back 13 is pivotally displaceable about hinge 38 as indicated by arrow 39. A releaseable catch is provided at 40 for securing the end 41 in seat back 13 to the side 42 of chair 10.

I claim:

1. A dog grooming salon chair comprising:
a supported seat with a chair back, said seat dimensioned to receive and confine the hind rump portion of a dog in a seated position with the rear paws of the dog exposed forward for grooming;
a forward protruding front paw tray removably secured on said chair and positioned above said seat and dimensioned and adjustable to confine the chest area of the seated dog in relation to the chair back whereby the front paws of the seated dog are supported on said front paw tray for grooming; and
a tether secured to said chair and detachably securable to the dog and dimensioned to thereby retain the dog in the chair in the seated position for grooming.

2. The dog grooming salon chair of claim 1, including a rear paw tray protruding forward from said chair and positioned to receive and support the rear paws of the dog overhanging a front portion of said seat for grooming the rear paws.

3. The dog grooming salon chair of claim 2, wherein said rear paw tray is adjustably slidable into and out of said chair.

4. The dog grooming salon chair of claim 2, said rear paw tray having a non-skid top surface.

5. The dog grooming salon chair of claim 1, said chair back including an opening adjacent said seat for protrusion therethrough of the dogs tail.

6. The dog grooming salon chair of claim 1, including a seat height adjuster.

7. The dog grooming salon chair of claim 1, wherein said chair back is displaceable for permitting access for larger dogs to walk into said chair from the back.

8. The dog grooming salon chair of claim 1, said tether comprised of at least two straps with outer ends thereof secured respectively to spaced side portions of said chair and inner ends thereof secured to a harness on the dog.

9. The dog grooming salon chair of claim 1, said front paw tray having a non-skid top surface.
